(19) United States
(12) Patent Application Publication
(10) Pub. No.: US 2015/0019347 A1
(43) Pub. Date: Jan. 15, 2015

(54) VIEWPORT BASED DISPLAY OF ADVERTISEMENTS

(71) Applicants: Nabil Naghdy, Camperdown (AU); Arnold Binas, Kirribilli (AU)

(72) Inventors: Nabil Naghdy, Camperdown (AU); Arnold Binas, Kirribilli (AU)

(21) Appl. No.: 13/838,714

(22) Filed: Mar. 15, 2013

(51) Int. Cl. G06Q 30/02

(52) U.S. Cl. CPC G06Q 30/0275
USPC 705/14.71

(57) ABSTRACT

A viewport based advertising auction is used to determine and provide advertisements to a user on a display device along with a map. The viewport based advertising auction is performed in response to a user selecting a geographical region of a map to view, and is limited to advertisers who have physical stores in the geographic region defined by the map being displayed on the display device. The winner of the advertising auction may be determined based on the price per click entered by the various advertisers in an auction, a predicted click through rate for the advertisers in the auction, and the distance from the user of the display device to one or more of the physical locations of the advertisers within the geographic region. In this manner, advertisers can elect to participate in advertising auctions limited to advertisers who have physical stores a region being viewed.

### FIELD OF TECHNOLOGY

This application relates generally to the display of advertisements on a display device, such as on a display screen of a mobile or fixed electronic display device, and more particularly to a viewport based method of performing an advertisement auction to determine an advertisement to display on a display screen of a display device in conjunction with a map.

### BACKGROUND

It is common to provide advertisements on display screens of fixed or mobile computing devices in conjunction with the users of these devices interacting with certain applications on the devices, such as searching applications, shopping applications, etc. or in conjunction with the user visiting certain websites, such internet auction or searching websites. Generally speaking, advertisers pay or contract with the service provider of the search engine, website, etc. to display the advertisers' advertisements to the user in response to certain actions being taken by the user. Generally speaking, in such situations, the service provider, e.g., the search engine provider, uses an advertising server to perform advertising decisions and functions. The advertising server generally stores advertisements associated with various advertisers who are willing to pay to have their advertisements displayed to a user in conjunction with the application or the website, and the server performs an advertisement auction between various different advertisers to determine which advertisements, and the order of advertisements, to be displayed to the user via the display device. A common method of performing such an advertisement auction uses the concept of advertising words or phrases or other search terms. In this case, the advertisers select to participate in an auction, and therefore to have their advertisements displayed to the user, when a user performs a search in an application or via a website using a predetermined word or phrase that the advertiser believes would indicate a potential interest in the advertiser's product or service.

In these types of advertising auctions, advertisers essentially bid to have their advertisements displayed to any user that performs a search using a predetermined word or phrase or when a user otherwise enters a particular term or phrase via the application or website. Here, the advertisement server that performs the auction stores the maximum amount that each of the advertisers has agreed to pay, generally referred to as a maximum price per click (PPC), for having their advertisement viewed by a user when the user enters or uses a particular word or phrase, and uses these maximum PPCs to perform the auction each time a user enters or uses the term or phrase.

More specifically, the advertisement server performs an auction in real time (e.g., at the time that a particular term or phrase is used in a search engine or is otherwise entered by a user) by determining all of the advertisers who have subscribed to participate in an auction for that particular term or phrase, and then determining the winner or winners of the auction (e.g., by ranking the winners of the auction in an ordered list, such as the top five winners of the auction), based on the maximum price that the advertisers are willing to pay for the display and ultimate section of their advertisements by the user. In many cases, the advertisement server determines the winner of the auction by determining the lowest amount that one advertiser needs to pay (i.e., a prices that falls below the advertiser's maximum PPC) that is still higher or greater than any other advertiser's maximum PPC. It should be noted that, typically, advertisers contractually agree to pay the winning price of the auction, up to the maximum PPC, when the user actually selects, “clicks on” or “clicks through” the advertisement, after the advertisement or some indication of the advertisement is initially displayed to the user. Thus, in response to winning an action, an advertisement icon for the winner of the auction is first displayed to the user on the display device, wherein the advertisement icon indicates the existence of a more detailed advertisement. The complete advertisement is only displayed to the user when the user clicks on or selects the advertisement icon. When the user performs this action, however, the auction winner becomes contractually obligated to pay the service provider or auctioneer the winning price of the auction.

In some cases, the advertisement server performs a slightly more complicated auction by factoring a predicted click through rate (PCTR) into the analysis of determining the winner of an auction. In a general sense, a service provider performing an auction may find it desirable to incorporate a PCTR into the auction process to statistically increase the revenue the service provider collects from advertisers by increasing the likelihood that the user, when presented with an advertisement icon, will actually click on or select that icon and thus generate a billing event. The PCTR is typically a historical or otherwise predicted rate or percentage of the time that a particular advertising icon or that an advertising icon of a particular advertiser is selected by a user after being displayed to the user. A high PCTR indicates that it is more likely that users who view the advertisement icon will select or click on that icon to view the full advertisement, and thus generate a billable event. Because it is the selection of a displayed advertising icon, and not the initial display of the advertising icon itself, that generates the billable event, it is statistically better for the service provider to accept a slightly lower bid price from the winner of the auction if the winner's advertisement icon has a PCTR sufficiently (or in some cases even slightly) higher than another advertiser that is willing to pay the same amount or more for a billable event. Generally, the advertisement server stores and updates a PCTR for each advertisement or advertiser for use within the various auctions, and the advertisement server determines the winner of an auction as the advertiser who has a bid price that, when multiplied by the PCTR of that advertiser, is higher than the product of the PCTR and the maximum PPC of any other advertiser in the auction. Thus, in many cases, the auction may not be won by the advertiser who provides the highest maximum PPC, but by the advertiser whose has the highest product of its maximum PPC and PCTR.

In each of these situations, the advertisers bid on the opportunity to provide advertisements to a user in response to the user using or entering a search term or phrase. However, there are many situations in which users take actions via the screen of a display device or within an application or website that do not involve entering a search term or phrase, but in which it still might be desirable to provide an advertisement to the user. In these situations, the service provider has no effective manner of running an auction and thus serving up advertisements in an auction-based advertising system.

### SUMMARY

A method and system of providing advertisements to a user on a display device in a manner that does not require the user to enter any search terms or phrases to initiate an advertising auction includes performing a viewport based advertising auction in response to a user viewing or selecting a geographical region of a map to view, and performing the advertising auction between advertisers who have physical locations, such as business locations, service locations, stores, etc. (sometimes referred to as brick and mortar stores) in the geographic region defined by the map displayed within the viewport of the display device. The method of providing advertising may determine the winner of the auction based on factors such as the price per click entered by the various advertisers, a predicted click through rate for the advertisers, and the distance from the user of the display device to one or more of the physical locations of the advertisers within the geographic region. In this manner, advertisers who have physical, e.g., brick-and-mortar, stores can participate in an advertising auction to provide advertisements to users who are viewing a map of the geographic region in which the brick-and-mortar stores are located and who are thus more likely to actually visit these stores. This new type of advertising auction may, in many cases, be more effective in getting users of mapping applications to visit or interact with stores than traditional search term based auctions, and these auctions can be initiated even when a user does not enter or use a search term or phrase.

In one embodiment, a method of presenting an advertisement to a user on a display screen of a display device in conjunction with a map includes determining a geographical region associated with the map being displayed on the display device, determining one or more advertisers having at least one associated physical location within the geographical region associated with the map being displayed on the display device and performing an auction between the advertisers having at least one associated physical location within the geographical region associated with the map being displayed on the display device to determine an advertisement to display in conjunction with the map on the display device. The method further includes displaying the advertisement for the winner of the auction on the display device in conjunction with the map. If desired, displaying the advertisement may include displaying an advertisement icon on the display screen indicating the existence of an advertisement in conjunction with the map, and further displaying a complete advertisement on the display screen in response to a user selection of the advertisement icon. Still further, performing the auction between the advertisers may include determining the winner of the auction based on a price that each advertiser is willing to pay for the viewing of an advertisement and based on none, one or both of a predicted rate at which a user will select a particular advertisement icon for an advertiser when displayed on the display screen and a distance from the display device to an associated physical location of an advertiser within the geographical region associated with the map displayed on the display screen. Using a distance from the display device to a physical location of an advertiser may include determining a multiplier based on the distance of the display device from the associated physical location of an advertiser within the geographical region associated with the map being displayed on the display device and combining the multiplier with the price to determine the winner of the auction. Likewise, determining the winner of the action may include filtering the advertisers that participate in the auction based on one or more filtering criteria specified by the advertisers for the auction, such as demographic filtering criteria. Moreover, the advertising method may track the amount of time the advertisement icon has been displayed on the display device without a user selecting the icon, and may present a different advertisement icon on the display screen of the display device after the expiration of a predetermined amount of time.

In another embodiment, an advertisement display system for presenting an advertisement to a user on a display screen of a display device in conjunction with a map includes a map database server including a first routine stored on a non-transitory computer readable memory, that executes on a processor to determine a geographical region associated with a map displayed on the display device and an advertising server that includes a second routine stored on a non-transitory computer readable memory, that executes on a processor to access a database to determine one or more advertisers having at least one associated physical location within the geographical region associated with the map being displayed on the display device. A third routine stored on a non-transitory computer readable memory executes on a processor to perform an auction between the advertisers determined to have at least one associated physical location within the geographical region associated with the map displayed on the display device to determine an advertisement to display in conjunction with the map on the display device. Moreover, a display device that is communicatively coupled to the map database server and the advertising server includes a fourth routine stored on a non-transitory computer readable memory, that executes on a processor to display the advertisement for the winner of the auction on the display device in conjunction with the map.

In yet another embodiment, a method of performing an auction for the placement of advertisements includes storing information for multiple advertisers including, for each advertiser, an advertisement, a price the advertiser is willing to pay for the advertisement and an indication of one or more physical locations associated with the advertiser, detecting the boundaries of a geographical region associated with a map displayed on a display device and determining one or more advertisers who have an associated physical location within the boundaries of the geographical region associated with the map displayed on a display device based on the stored information for the multiple advertisers. The method also includes performing an auction between the one or more advertisers determined to have an associated physical location within the boundaries of the geographical region associated with the map displayed on a display device using the price each of the determined advertisers is willing to pay for the advertisement, the auction determining a winner based in part of the price each of the determined advertisers is willing to pay for the advertisement. The method also includes sending the advertisement of the winner of the auction to a display device for display.

In another case, a system for performing an auction for the placement of an advertisement on a display device includes a data collection unit, a data storage unit and an auction unit. The data collection unit collects advertising data from each of a multiplicity of advertisers willing to participate in an advertising auction, and collects, for each of the multiplicity of advertisers, an advertisement for display on the display device, a price the advertiser is willing to pay for the display of the advertisement on the display device and an indication of a geographical location of one or more physical sites associated with each of the multiplicity of advertisers. The data storage unit stores the advertisement, the price the advertiser is willing to pay for the display of the advertisement on the display device and the indications of the geographical locations of the one or more physical sites associated with the advertiser for each of the multiplicity of advertisers. Moreover, the auction unit performs an advertisement auction between one or more of the advertisers having a physical site within a specified geographical region as determined from the indications of the geographical location of the one or more physical sites associated with the advertisers as stored in the data storage unit, using the price each of the advertisers is willing to pay for the display of the advertisement on the display device to determine a winner of the auction.

In another embodiment, a system for performing an auction for the placement of advertisements includes means for storing information for multiple advertisers including, for each advertiser, an advertisement, a price the advertiser is willing to pay for the advertisement and an indication of one or more physical locations associated with the advertiser, means for detecting the boundaries of a geographical region associated with a map displayed on a display device and means for determining one or more advertisers who have an associated physical location within the boundaries of the geographical region associated with the map displayed on a display device based on the stored information for the multiple advertisers. The system also includes means for performing an auction between the one or more advertisers determined to have an associated physical location within the boundaries of the geographical region associated with the map displayed on a display device using the price each of the determined advertisers is willing to pay for the advertisement, the auction determining a winner based in part of the price each of the determined advertisers is willing to pay for the advertisement, and includes means for sending the advertisement of the winner of the auction to a display device for display.

### BRIEF DESCRIPTION OF THE DRAWINGS

FIG. 1 illustrates an advertising system used in conjunction with a mapping system to provide advertisements to users of display devices in conjunction with maps using a view-port based advertising auction.

FIG. 2 illustrates an example mobile display device in which the maps and advertisements provided by the system of FIG. 1 can be displayed and viewed.

FIG. 3 illustrates a display screen that may provided to an advertiser to set up a viewport based advertising campaign.

FIG. 4 is a flow chart of a method or routine that may be used on an advertising server to implement a viewport based advertising auction.

FIG. 5 is a flow chart of a method or routine that may be used on a display device to provide and display advertisements generated using a viewport based advertising auction to a user in conjunction with displaying a map.

### DETAILED DESCRIPTION

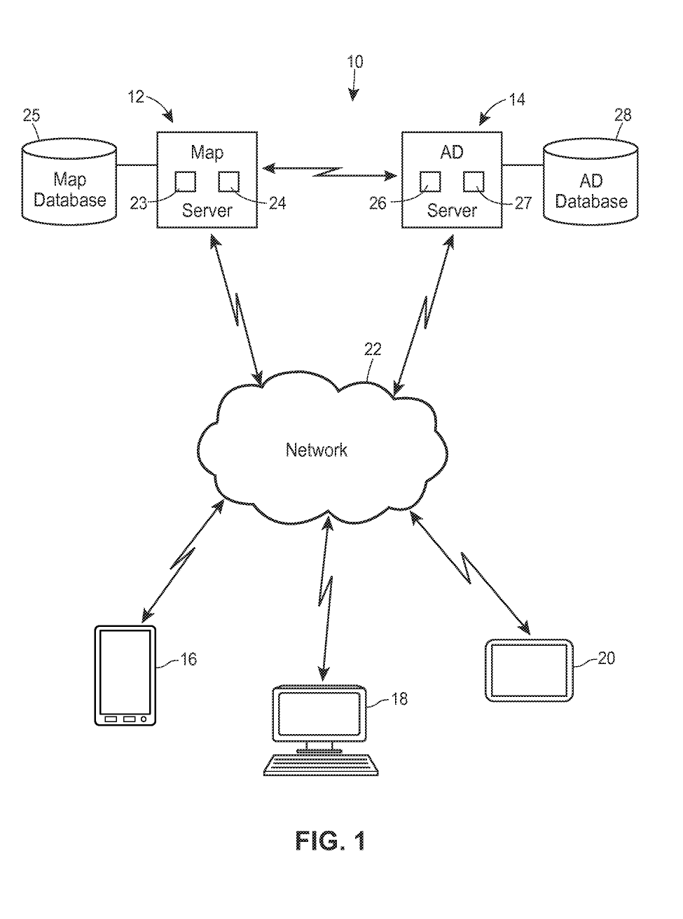

FIG. 1 illustrates an advertising and map display system 10 which may implement a viewport based advertising auction to provide advertisements to display devices in conjunction with a map. Generally speaking, the advertising and map display system 10 includes a map database server 12, an advertising server 14 and multiple display devices 16, 18 and 20 connected to one another and to the servers 12 and 14 via a communications network 22, which may be an internet or an intranet network or any other kind of communications network. In this case, the display device 16 is illustrated as being a mobile phone, the display device 18 is illustrated a being a computer workstation and the display device 20 is illustrated as being a computer tablet device. However any other types or kinds of display devices, such as display devices in automobiles, stores, etc., may be used and may be communicatively connected to the servers 12 and 14 for displaying advertisements in conjunction with maps. As illustrated in FIG. 1, the map database server 12 includes a non-transitory computer readable memory 23 that stores one or more map routines and a processor 24 that executes the one or more map routines to obtain map data from a map database 25 and to provide the map data to one or more of the display devices 16, 18 and 20. Likewise, the advertising server 12 includes a non-transitory computer readable memory 26 that stores one or more advertising auction routines and a processor 27 that executes the one or more advertising auction routines to obtain advertising data from an advertising database 28, to perform a viewport based advertising auction and to provide or serve advertisements to one or more of the display devices 16, 18 and 20 for display in conjunction with the map generated from the map data provided to the one or more display devices 16, 18 and 20 by the map database server 12.

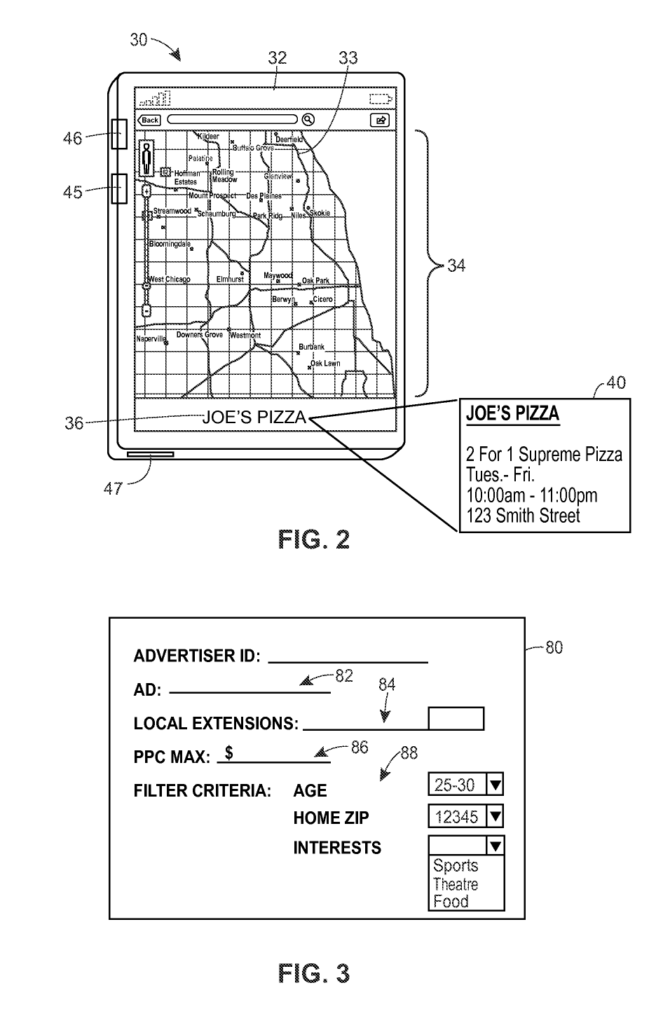

As a more specific example, FIG. 2 illustrates a mobile computing device 30 including a display screen 32 that is depicted as displaying within a viewport 34 a map 33 of a geographic region selected by a user. Here, the viewport 34 of the device 30 may be smaller than the display screen 32 and generally defines the boundaries of the display screen 32 that are used to display the map 33 as part of a map viewing application executed on the device 30. The map 33 displayed within the viewport 34 includes geographical boundaries that may be defined by, for example, the edges of the map 33 displayed within the viewport 34. However, the map boundaries could be different, and may, for example, be defined by the boundaries of the map tiles downloaded to the device 30 as part of the operation of the map application. Additionally, an advertising icon 36 may be displayed at, for example, the bottom of the display screen 32, although the advertising icon 36 may be displayed at other locations on the display screen 32 as well or instead. Generally speaking, the advertising icon 36 may be any sort or size of icon which, when clicked or otherwise selected by the user (such as by a touch event, a mouse selection, a voice command, etc.) expands into a fuller or more complete advertisement providing more information associated with the advertisement, as is illustrated by the blow-out screen 40 of FIG. 2. That is, when the user selects the advertising icon 36, the display device 30 may display a full blown advertisement, or at least more information about an advertisement, on the display screen 32 on or over the map 33 being displayed on the display screen 32.

Generally speaking, a map application 41 is illustrated as being stored in a non-transitory computer readable memory 45 and is executed on a processor 46 of the display device 30 to communicate via a communications interface 47 over the communications network 22 of FIG. 1 with the map database server 12 to obtain map data for displaying the map 33 in the viewport 34 in any desired manner. The map data may, for example, be vector-based map data or raster image based map data, or may be any other type of map data used to generate a map in any other manner. Still further, the map application 41 communicates via the interface 47 and the communications network 22 with the advertising server 14 to receive the advertising icon 36 and displays the advertising icon 36 on the display screen 32 in conjunction with the map in the viewport 34. The communications interface 47 of the mobile device 30 communicates with the map database server 12 and the advertising server 14 in any known or desired manner to obtain the map data for the map as well as the advertising icon 36 and the full or complete advertisement 40 which may be displayed when the advertising icon 36 is selected or clicked by a user.

In a general sense, the user interacts with the display device 30 to select or view a certain geographical region or portion of a map as stored in the map database 12, and the map application 41 obtains the map data for the selected geographical region via the communication interface 47 from the map database server 12. Of course, the map database server 12 obtains the map data from the database 25 which stores map information in any known or desired manner. As part of this process, however, the map database server 12 may communicate directly or indirectly with the advertising server 14 to provide details about the displayed geographical region, such as the boundaries of the geographical region to be displayed on the device 30, in response to a user's interaction with the device 30. Upon receiving a new set of geographical or map boundaries from the map database 12, the advertising server 14 may execute one or more auction routines to generate or perform an auction for advertisers based on the boundaries of the map to be displayed on the user interface device 30.

In particular, the advertising database 28 stores information that the advertising server 14 uses to perform a viewport based advertising auction including, for example, identifications of advertisers who wish to participate in the auction, actual advertisements and/or advertising icons for each of those advertisers to be displayed to users when an advertiser wins an auction (or when an advertising icon that wins the auction is displayed to and selected by the user) and a maximum price that each advertiser is willing to pay when a user selects an advertisement icon for viewing when that icon is displayed on the display device as a result of winning an auction (referred to herein as the maximum price per click or maximum PPC). Still further, the database 28 may store geographical locations of one or more physical locations or sites associated with each of the advertisers (referred to herein as local extensions), including the physical locations (sites) of stores, sales offices, or other brick-and-mortar locations of advertisers. The database 28 may also store or obtain a predicted click through rate (PCTR) for each advertisement or advertiser that participates in the auction. As described above, the PCTR defines or predicts the likelihood that a user will click or select the advertisement icon of an advertiser, and thus generate a billable event, when that icon is displayed to the user as a result of winning the auction.

When running or implementing a viewport based advertising auction, the auction routines within the advertising server 14 may first or initially determine which advertisers participate in the auction based on the boundaries of the map to be displayed to the user on a display device, by limiting the auction to only those advertisers having one or more local extensions within the boundaries of the map to be displayed on the display device. Thereafter, the advertising server 14 performs an auction using the maximum PPC for each of the advertisers that are participate in the auction, as well as, if desired, the PCTR for each of those advertisers, to determine the winner of the auction.

In some instances, the advertising server 14 may filter out some of the advertisers who have local extensions within the boundaries of the map to be displayed to the user, based on filtering criteria selected by or specified by the advertisers and stored in the database 28. More particularly, in some cases, the advertisers may provide filtering criteria as part of the auction process to allow the advertisers to elect to participate or not participate in an auction based on demographic or other types of information about the user of the display device. The filter criteria may include or use demographic or other types of information that may be collected by the advertising server 14 or the map database server 12 in various known manners, and this information may include for example, age information, recent searches, home region (such as the zip code of the home address), information regarding interests of the user, etc. Thus, for example, an advertiser may only want to participate in a viewport based advertising auction when the user is someone that falls within a particular age bracket, or who is known or previously self-identified as having a particular interest in, for example, sports, food, the ballet, or who lives in a particular geographic area or region, etc. Of course, any other types of demographic and other information may be specified by the advertisers as well or instead to perform filtering. The advertising server 14 may filter out any advertisers who, while having local extensions within the geographic boundaries of the map to be displayed on the display device, do not wish to participate in the auction based on these other filter criteria.

Moreover, in performing a viewport based advertising auction, the advertising server 14 may use the location of the user of the display device to determine the winner of the auction. In particular, the advertising routines on the advertising server 14 may determine, for any particular auction, the distance from the physical location of the display device on which the map is to be displayed to one or more of the local extensions of the advertisers within the map boundaries, and may use this distance as a factor within the auction. In this case, the advertising server 14 may obtain or receive the physical location of the display device, as determined by a GPS system of a display device as part of the mapping application, or as determined in other manners, such as by using an approximate location determined from the IP address of the server through which the communications are taking place from the display device 30, as self-identified by the user, or in any other manner. The advertising routines or the advertisement server 14 may calculate the distance between that display device and one or more of the physical locations of the advertisers within the map boundaries, and assign a weighting factor based on the calculated distance. In many cases, the closer the user is to a local extension of an advertiser, the higher the weighting factor for that advertiser will be. The theory here is that the user is more likely to click on or select an advertisement for a business or local extension that is physically very close to the user than one that is further away from the user but still within the displayed geographic map region. Thus, for example, when the display device (and thus the user) is a block away from a location of one of the advertisers participating within the auction, that advertiser may receive a weighting factor of 1.4, while when the user is three blocks away from a location of an advertiser within the auction, the advertiser may receive, for example, a waiting factor of 1, and when the user is a mile away from the advertiser's location, the advertiser may receive a weighting factor of, for example, 0.5. Of course, the distance based weighting factors may be determined or selected in any desired manner and may range between any desired values, such as from 0 to 1, 0 to 10, etc.

When using distance weighting factors, the advertising auction routines on the advertising server 14 may multiply or otherwise combine the distance weighting factor for each advertiser participating within the auction with one or both of the max PPC and the PCTR for each advertiser participating within the auction to determine the winner of the auction. In this case, advertisers who actually provide a maximum PPC that is less than another advertiser's max PPC, but has a geographic location closer to the user of the display device viewing the map may still win the auction, even when both advertisers have the same PCTR.

In any event, upon determining the winner of the auction, the advertising server 14 provides the winning advertisement (which may include an advertising icon) to the display device 30 via the communications network 22 for display in conjunction with the map as provided to the display device 30 by the map database server 12. Of course, the advertising server 14 may provide a list of the winners of each auction to the display device 30 as an ordered set, so that the second-place winner, third place winner, etc. are indicated and so that the associated advertisements and advertisement icons for these runners-up are provided to the display device 30. The ordered list of winners and their associated advertisements and advertisement icons may be provided initially with the winner's advertisement and advertisement icon, or may be provided later in separate communications when needed, as discussed in more detail below. Additionally, if desired, the advertising server 14 may provide, as the advertisement, the advertising icon for the winner, and may then provide the full scale or additional advertisement information for the winner, to be displayed to the user, when the user selects or clicks on the advertising icon.

Upon receiving advertisement and the map data, the map application 41 of the display device 30 displays the advertising icon of the winner in conjunction with the map. Moreover, when the user selects the advertisement icon, the map application 41 will then display the full advertisement 40 and may then generate a billable event that is sent back to, for example, the advertisement server 14 for use in billing the winner of the auction.

If desired, either the advertising server 14 or the mapping application 41 may operate to determine the length of time that the advertising icon 36 is displayed on the display device 30 without the user either selecting the advertising icon 36 or changing the map (e.g., regenerating the map being displayed on the display device to cover a different geographical region). After a certain predetermined amount of time has elapsed without the user selecting the advertising icon 36 or changing the map boundaries, the map application 41 may automatically display the advertising icon for the next-highest bidder (the second place winner) of the advertising auction on the display device 30 as the advertising icon. This action may, again, increase the likelihood of a billable event because, while the user may not be interested in the first advertisement, the user may be interested in the second advertisement. Of course, the advertisement server 14 or the map application 41 may continue to perform this time-out procedure, and provide the next advertising icon from the next advertiser in the ordered list of winners, in the order in which these advertisers placed in the advertising auction, to display advertisements to the user which might be more interesting to the user. As noted above, either the mapping application 41 or the an auction routine on the advertising server 14 may track and detect the expiration of a time out and may operate to obtain (or send) the next advertising icon and to display that icon on the display device 30. Additionally, the selection or non-selection of each displayed advertising icon may be detected by either the mapping application 41 or the advertising server 14 and be used to change, affect or calculate the PCTR for that advertisement or advertiser, as stored in the database 28 of the advertising server 14.

FIG. 3 illustrates a screen 80 of a display device that may be generated by, for example, by one of the auction routines on the advertising server 14 in the process of collecting or establishing an advertising campaign to use in performing viewport based advertising auctions. The display device 80 of FIG. 3 may be displayed to an advertiser to enable the advertiser to provide information needed to fill out an advertising campaign for that advertiser, wherein the advertising campaign allows the advertiser to participate in the geographically or viewport based advertising auctions described herein. In particular, when filling out an advertising campaign, one of the auction routines within the server 14 may provide various fields to the advertiser, that the advertiser may use to provide information used to create an advertising campaign. As illustrated in FIG. 3, the fields may include a description or identification field 82 identifying or specifying the advertiser and/or of the advertisement that will participate in the auction, and a local extension field 84 which may be used to provide, identify or specify one or more local extensions (e.g., physical stores, shops, service centers, etc.) that will be used to participate in the advertising auction. In particular, the advertiser may use the field 84 to establish or select one or more physical locations associated with the advertiser to be used as the local extensions for that advertiser for the advertising campaign. An advertiser may, for example, select each store or other physical location associated with that advertiser or may select a subset of all of its locations being less than all of the advertiser's locations. In this manner, the advertiser can limit the advertising campaign to particular local extensions or to particular physical locations for which the advertisement is most relevant. For example, a chain restaurant may only want to limit an advertisement directed to a new product that is still in a test phase to only those locations that actually sell the new product as part of the test phase. In event, the advertising server 14 enables the advertiser to specify its local extensions in any desired manner, such as by inputting addresses of the local extensions, using a map tool to select physical locations at which the advertiser's local extensions are located within a map, by specifying locations or stores already known or stored in a map database, such as in the map database 25 of the map database server 12, etc.

Still further, the display 80 may include a price field 86 in which the advertiser may select or specify the maximum PPC it is willing to pay to win auctions, and which price will be used by the advertising server 14 to determine the winner(s) of viewport based auctions. Also, the display 80 include a filter field 88 in which the advertiser may provide or select certain filters or filtering criteria for the advertising campaign. The filter field 88 may include a number of pre-established sub-fields, with each sub-field specifying a different, for example, demographic filter, such as an age subfield, a home zip code subfield, an interests subfield, etc. Of course, the advertiser may specify a sub-set of these different types of demographic information using preset or pre-established values or ranges, or the advertiser may manually specify a particular value or range to use for one or more of these sub-fields. The filter criteria is not limited to that specified herein and could include any other kinds of demographic information which may be used by advertisers to limit their participation in auctions to users having specific demographic profiles. Of course, after the advertiser enters in the appropriate information into screen 80, this information is stored in the database 28 for use in determining winners of auctions by the advertising server 14. In situations in which the systems discussed herein collect personal information about users, or make use of personal information, the users may be provided with an opportunity to control whether the programs or features collect user information (e.g., information about a user's social network, social actions or activities, profession, a user's preferences, or a user's current location), or to control whether and/or how to receive content from the advertising server that may be more relevant to the user. In addition, certain data may be treated in one or more ways before it is stored or used, so that personally identifiable information is removed. For example, a user's identity may be treated so that no personally identifiable information can be determined for the user. In any event, the user may have control over how information is collected about the user and used by a content or advertising server.

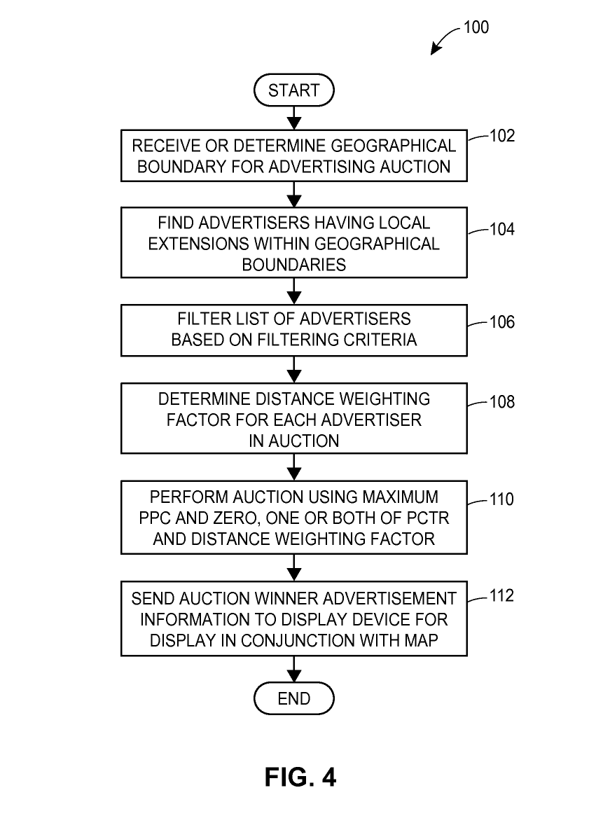

FIG. 4 illustrates a flowchart 100 which may be used or performed by, for example, one of the auction routines stored within the memory 26 of the advertising server 14 and executed on the processor 27 to perform a viewport based advertising auction. In particular, a block 102 may initiate or start a viewport based auction by receiving geographical boundary information defining map or viewport limits (e.g., map boundaries) of a map that is being or that will be displayed on a display screen of a display device. The map database server 12 may provide this information directly to the advertising server 14 when the map database server 12 sends the map information to the user device (e.g., the user device 30 of FIG. 2) for display, or the user device 30 that implements the map application thereon may communicate this information to the advertising server 14, in conjunction with sending a request for map information to the map database server 12 or in conjunction with receiving requested map information from the map database server 12. It should be noted that the map database server 12 and the advertising server 14 may be in the same computing device or in different computing devices, and thus may communicate directly with one another or may communicate via a separate communication network or via the public communication network 22 of FIG. 1. Likewise, it should be noted that, while the advertising server 14 may use the geographical boundaries of the map as displayed on the viewport of the display device as the geographical boundaries for the auction, the advertising server 14 may use other geographical boundaries including more limited (smaller) or less limited (larger) boundaries than the boundaries of the map within the viewport as the geographical boundaries used in the advertising auction. Generally speaking, however, the geographical boundaries used to perform the viewport based auction will include a least a portion of the geographical region depicted in the map displayed on the viewport of the display device.

Upon receiving the geographical or map boundary limits for the map to be displayed on the viewport of a display device 30, a block 104 searches through the advertising database 28 that stores the various campaign information filled out or provided by advertisers, to determine a list of the advertisers who have specified local extensions that fall within the geographical or viewport boundaries of the map to be displayed on the display device 30. Thereafter, a block 106 may use the filtering criteria to filter out various ones of the advertisers based on the filtering criteria (e.g., the demographic information) stored as part of the advertiser's advertising campaigns. Of course, the advertising server 14 may obtain the demographic information from or about the user of the display device in various manners, such as from the database 28, from the user device directly, from a user profile created by and stored by the user, etc. In any event, the block 106 of the auction routine compares the user demographic information to the filtering criteria in each of the campaigns of the advertisers detected in the block 102, to reduce or eliminate advertisers that do not want to participate in the auction based on one or more of these filtering criteria.

A block 108 may then determine one or more distance weighting factors by determining a distance from the display device to each of the local extensions of the advertisers still remaining in the auction. The physical location of the user or the display device on which the advertisement is to be placed may be determined from the device itself (such as using the GPS coordinates as detected and transmitted by the display device itself) or from information about the device, such as network identification information identifying the physical locations of devices used in the communication network through which the display device is communicating with the map database server 12 and/or the advertising server 14. Additionally, in some cases, the user of the display device may be able to specify the user current location or provide other location information that enables the server 14 to determine the distance between the display device and one or more of the local extensions of the advertisers within the auction. Generally speaking, when more than one local extension of an advertiser falls within the geographical map boundaries for the auction, the distance may be determined between the user and the local extension that is closest to the user.

Thereafter, the block 108 determines a weighting factor for each advertiser based on the distance from the user or display device to one or more of the advertiser's local extensions within the geographical boundaries of the auction (e.g., the viewport boundaries). This weighting factor may be calculated, may be determined via a look up table, or may be determined in any other suitable or desired manner.

Next, a block 110 performs a viewport based advertising auction by combining neither, one or both of the distance weighting factor and the PCTR determined for each advertiser or advertisement within the auction with the associated maximum PPC for the advertisers in the auction to determine the one or more the winners of the auction or an ordered list of winners. In particular, the auction routine when executed on the advertising server 14 may start the auction and determine the advertiser that has the highest product of max PPC, distance weighting factor and PCTR to determine a winner of the auction. The winning price of the auction may then be determined as the PPC for that advertiser that puts the product of the PPC, the winner's PCTR, and the winner's distance weighting factor just higher than the product of the second highest advertiser's maximum PPC, PCTR and distance factor. This second place winner (and the second place winning price) may be performed in the same manner between the second place winner and the next highest winner (the third place winner), and so on, to produce the ordered set of winners and winning auction prices. Of course, the advertising server 14 may perform the auction in any other desired manner. For example, the advertising server 14 may perform the auction based solely on the maximum PPC for each advertiser, based on the product of the maximum PPC and the PCTR of each advertiser, based on the product of the maximum PPC and the distance weighting factor of each advertiser, etc.

In any event, upon determining the winner of the auction, a block 112 provides or sends the auction winner, or at least the advertisement and/or the advertisement icon for that winner to the display device 30 via the communications network 22 of FIG. 1. Additionally, if desired, the advertising server 14 may provide the ordered set of winners, such as the advertisement and/or the advertisement icon of the second-highest winner, the third-highest winner, etc. for display by the device 30 at other times. While the block 112 could send the winning advertising information directly to the display device, the block 112 may also or instead send the advertisements and icons to the map database 12 for delivery to the user. That is, the map database server 12 may call the advertising server 14 to perform an auction, and in this case the map database server 12 may provide the needed geographical map boundary information, as well as other user information such as demographic information to the advertising server 14, and may receive advertising auction winner information from the advertising server 14 to be sent to the display device as part of the map data.

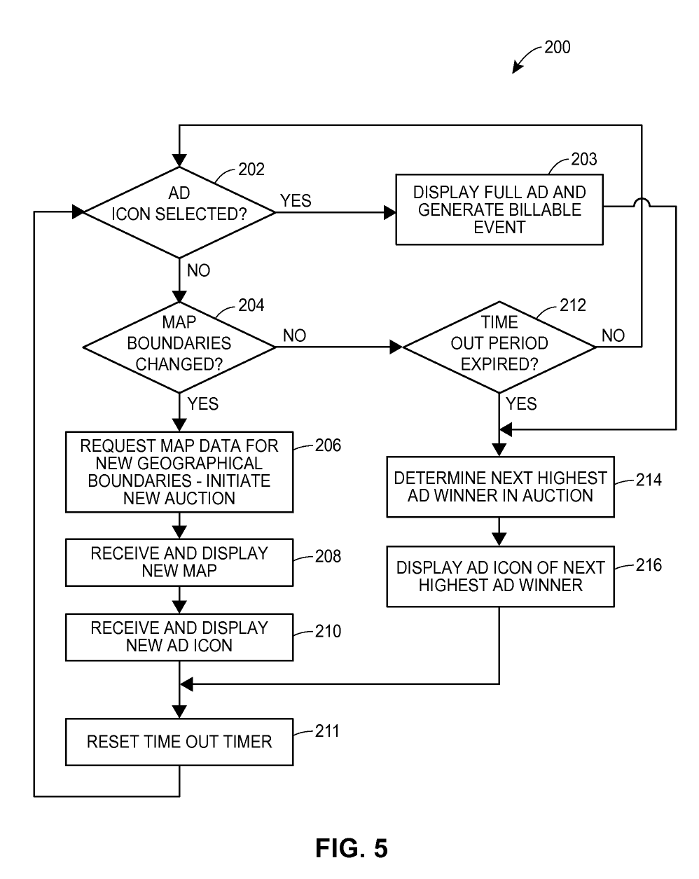

FIG. 5 illustrates a flowchart 200 that may be used in, for example, the display device 30 or as part of the map application 41 as a portion of the process of performing or initiating viewport based advertising auctions. The flowchart 200 includes a block 202 that may, for example, operate when or after an advertisement icon and a map have been displayed to a user, which may initially occur when, for example, a user opens a map application to initially view a map or closes or minimizes a map and then reopens the map. The block 202 checks to determine whether the user has clicked on or selected the advertising icon currently being displayed and, if so, a block 203 operates to present the additional advertising information associated with the advertising icon on the display device 30 and generates a billable event. Control may return to the map application thereafter when the user closes the advertisement, at which time a new advertisement icon may be displayed to the user.

However, if the advertising icon has not been selected at the block 202, a block 204 determines if the user has changed the map boundaries for display by, for example, selecting a new map or a different geographical area to view as a map (such as by moving the viewport boundaries to cover a different geographical region, panning the map, zooming in or out of the map, etc.) Moreover, closing the map application and reopening the map application may also be detected at the block 204 as changing the map boundaries, and thus initiate a new advertising auction. If the user has changed or has requested a change of the map boundaries, a block 206 determines the new viewport or map boundaries and sends a request to the map database server 12 to obtain new map data for display via the viewport of the display device. The user may, for example, request a completely new map region, may pan the map in one or more directions, may zoom in or out of the map, or take other actions to change the map boundaries. Any or all of these cases may cause the initiation of a new advertising auction at the advertising server 14, as a different set of advertisers is now implicated or available for a new advertising auction based on the new geographical boundaries. A block 208 may then receive and display the map data for the new boundaries on the viewport of the display device, and a block 210 may receive and display the advertising icon of the winner of the advertising auction as provided by the advertising server 14. Thereafter, a block 211 resets a time out timer to zero and control may be returned to the block 202 to determine whether the new and now currently displayed advertising icon has been selected to generate a billable event.

However, if there has been no change to the map boundaries of the viewport at the block 204, a block to 212 determines whether a predetermined time out period has expired since the last time a new advertising icon has been displayed. If the time out period has not expired, control returns to the block 202 which determines if the user has selected the currently displayed advertising icon. The loop comprising the blocks 202, 204 and 212 then repeats until the user selects the advertising icon, changes the map boundaries on the viewport or the time out period expires.

When the block 212 determines that the time out period (which may be, for example, 10 seconds, 30 seconds, one minute, etc.) has expired, or after a user closes an advertisement displayed by the block 203, a block 214 determines a new advertising icon to display on the viewport of the display device by determining the next highest winner of the auction for which an advertising icon has not yet been displayed to the user. Typically, the advertising icon will be the advertising icon of the next winner in the ordered set of winners previously determined by the advertising server 14 during the initial advertising auction. The block 214 may obtain this information from a memory of the device 30 or may communicate with the advertising server 14 to obtain this information. If desired, this time out expiration may instead initiate a new auction not including the advertisement that just timed out or that was viewed by the user. A block 216 then displays the new advertising icon of the next winner of the auction in the ordered set of winners and control is provided to the block 211 which resets the timer used to determine a time out event. Thereafter, once again, the blocks 202, 204 and 212 operate in a series or looped manner to determine whether the user either clicks on or selects the advertising icon (to see a full-blown advertisement and initiate a billable event) or changes the map boundaries of the viewport and to detect the expiration of a time out, and thereby display a new advertising icon for possible selection by the user. Of course, while the flowcharts of FIGS. 4 and 5 illustrate one manner of performing a viewport based advertising auction and displaying the results of that auction, the steps of these flowcharts could be changed in any desired or useful manner, and other methods of performing these functions could be implemented instead.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms or units. Modules and units may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

A hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for performing viewport or geographical based advertising auctions based on the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method of presenting an advertisement to a user on a display screen of a display device in conjunction with a map, comprising:
determining, with one or more processors, a geographical region associated with the map being displayed on the display device;
determining, with one or more processors, one or more advertisers having at least one associated physical location within the geographical region associated with the map being displayed on the display device;
performing, with one or more processors, an auction between the advertisers having at least one associated physical location within the geographical region associated with the map being displayed on the display device to determine an advertisement to display in conjunction with the map on the display device, wherein the determination of the winner of the auction is based in part on the distances of the associated physical locations from the location of the display device; and
displaying, with one or more processors, the advertisement for of the winner of the auction on the display device in conjunction with the map.

2. The method of presenting an advertisement on a display screen of a display device in conjunction with a map of claim 1, wherein displaying, with one or more processors, the advertisement includes displaying an advertisement icon on the display screen indicating the existence of an advertisement in conjunction with the map, and further displaying a complete advertisement on the display screen in response to a user selection of the advertisement icon.

3. The method of presenting an advertisement on a display screen of a display device in conjunction with a map of claim 1, wherein performing, with one or more processors, an auction between the advertisers having at least one associated physical location within the geographical region associated with the map being displayed on the display device to determine an advertisement to display in conjunction with the map on the display device includes determining the winner of the auction based on a price that each advertiser is willing to pay for the viewing of an advertiser advertisement and on a predicted rate at which a user will select a particular advertisement icon for of an advertiser when displayed on the display screen.

4. (canceled)

5. (canceled)

6. The method of presenting an advertisement on a display screen of a display device in conjunction with a map of claim 1, wherein determining, with one or more processors, the winner of the auction based in part on the distances of the associated physical locations from the location of the display device includes using a price each advertiser is willing to pay for the viewing of an advertisement, determining a multiplier based on the distance of the display device from the associated physical location of an advertiser within the geographical region associated with the map being displayed on the display device and combining the multiplier with the price to determine the winner of the auction.

7. The method of presenting an advertisement on a display screen of a display device in conjunction with a map of claim 6, wherein determining, with one or more processors, the winner of the auction includes filtering the advertisers that participate in the auction based on one or more filtering criteria specified by the advertisers and used in the auction.

8. The method of presenting an advertisement on a display screen of a display device in conjunction with a map of claim 1, wherein performing, with one or more processors, an auction between the advertisers having at least one associated physical location within the geographical region associated with the map being displayed on the display device includes limiting the auction to only advertisers having at least one associated physical location within the geographical region associated with the map being displayed on the display device.

9. The method of presenting an advertisement on a display screen of a display device in conjunction with a map of claim 1, wherein displaying, with one or more processors, the advertisement includes displaying an advertisement icon on the display screen indicating the existence of an advertisement in conjunction with the map, and further tracking, with one or more processors, the amount of time the advertisement icon has been displayed on the display device without a user selecting the icon, and presenting a different advertisement icon on the display screen of the display device after a predetermined amount of time.

10. The method of presenting an advertisement on a display screen of a display device in conjunction with a map of claim 1, further including, in response to a change in the geographical region displayed on the map, repeating the steps of determining, with one or more processors, one or more advertisers having at least one associated physical location within the geographical region associated with the map being displayed on the display device, performing, with one or more processors, an auction between the advertisers having at least one associated physical location within the geographical region associated with the map being displayed on the display device to determine an advertisement to display in conjunction with the map on the display device, and displaying, with one or more processors, the advertisement of the winner of the auction on the display device in conjunction with the map.

11. An advertisement display system for presenting an advertisement to a user on a display screen of a display device in conjunction with a map, comprising:
a map database server including a first routine stored on a non-transitory computer readable memory, that executes on one or more processors to determine a geographical region associated with a map displayed on the display device;
an advertising server that includes a second routine stored on a non-transitory computer readable memory, that executes on one or more processors to access a database to determine one or more advertisers having at least one associated physical location within the geographical region associated with the map being displayed on the display device and that includes a third routine stored on a non-transitory computer readable memory, that executes on one or more processors to perform an auction between the advertisers determined to have at least one associated physical location within the geographical region associated with the map displayed on the display device to determine an advertisement to display in conjunction with the map on the display device, wherein the third routine determines the winner of the auction at least in part based on the distances between the associated physical locations and the location of a display device; and
a display device communicatively coupled to the map database server and the advertising server that includes a fourth routine stored on a non-transitory computer readable memory, that executes on one or more processors to display the advertisement of the winner of the auction on the display device in conjunction with the map.

12. The advertisement display system of claim 11, wherein the map database server provides map data to the display device and wherein the display device displays the provided map data on a display screen.

13. The advertisement display system of claim 12, wherein the advertising server provides the advertisement to the display device to be displayed on the display screen in conjunction with the map.

14. The advertisement display system of claim 11, wherein the map database server is communicatively coupled to the advertising server and provides map data to the advertising server defining the geographical region associated with the map data sent to the display device.

15. The advertisement display system of claim 11, wherein the advertising server provides an advertising icon to the display device and the display device displays the advertising icon and wherein the advertising server provides an advertisement to the display device and the display device displays the advertisement when the user selects the advertising icon.

16. The advertisement display system of claim 11, wherein the advertising server includes a memory that stores a price that each advertiser is willing to pay for the viewing of an advertiser advertisement and stores a predicted rate at which a user will select a particular advertisement displayed on the display screen, and wherein the third routine performs the auction between the advertisers having at least one associated physical location within the geographical region associated with the map being displayed on the display device to determine an advertisement to display in conjunction with the map on the display device by determining the winner of the auction based on the price that each advertiser is willing to pay for the viewing of an advertiser advertisement and the predicted rate at which a user will select a particular advertisement displayed on the display screen.

17. (canceled)

18. (canceled)

19. The advertisement display system of claim 11, wherein the third routine determines a multiplier based on the distance of the display device from the associated physical location of an advertiser within the geographical region associated with the map displayed on the display device and combines the multiplier with the price that the advertiser is willing to pay for viewing of the advertisement to determine the winner of the auction.

20. The advertisement display system of claim 11, wherein the third routine limits the auction to only advertisers having at least one associated physical location within the geographical region associated with the map displayed on the display device.

21. The advertisement display system of claim 11, wherein the display device displays the advertisement by displaying an advertisement icon on the display screen indicating the existence of an advertisement in conjunction with the map, and wherein the display device includes a tracking routine that tracks the amount of time the advertisement icon has been displayed on the display device without a user selecting the icon and the fourth routine presents a different advertisement icon on the display screen of the display device after a predetermined amount of time.

22. A computer-implemented method of performing an auction for the placement of advertisements, comprising:
storing, in one or more databases on a non-transitory computer readable memory, information regarding multiple advertisers including, for each advertiser, an advertisement, a price the advertiser is willing to pay for the advertisement and an indication of one or more physical locations associated with the advertiser;
determining, with one or more processors, the boundaries of a geographical region associated with a map displayed on a display device;
determining, with one or more processors, one or more advertisers who have an associated physical location within the boundaries of the geographical region associated with the map displayed on a display device based on the stored information regarding the multiple advertisers;
performing, with one or more processors, an auction between the one or more advertisers determined to have an associated physical location within the boundaries of the geographical region associated with the map displayed on a display device using the price each of the determined advertisers is willing to pay for the advertisement, the auction determining a winner based in part of the price each of the determined advertisers is willing to pay for the advertisement and further based in part on the distance between the associated physical locations of the advertisers and the location of the display device;
sending, over a communications network and with one or more processors, the advertisement of the winner of the auction to a display device; and
displaying, with one or more processors, the advertisement of the winner of the auction on the display device.

23. The method of performing, with one or more processors, an auction of claim 22, further including storing, in one or more databases on a non-transitory computer readable memory, as part of the information regarding an advertiser, a predicted rate at which a user will select the advertisement of the advertiser when displayed on the display screen and wherein performing, with one or more processors, an auction includes using the predicted rate at which a user will select the advertisement of the advertiser when displayed on the display screen and determining the winner based on a combination of the price each of the determined advertisers is willing to pay for the advertisement and the predicted rate at which a user will select the advertisement of the advertisers when displayed on the display screen.

24. The method of performing, with one or more processors, an auction of claim 22, further including obtaining or receiving a physical location of the display device on which the advertisement is to be displayed and calculating a distance between the physical location of the display device on which the advertisement is to be displayed and one or more of the physical locations associated with the advertiser within the boundaries of the geographical region associated with the map displayed on the display device.

25. The method of performing, with one or more processors, an auction of claim 24, further including determining a weighting factor for the determined distance between the physical location of the display device on which the advertisement is to be displayed and one of the physical locations associated with one of the advertisers within the boundaries of the geographical region associated with the map displayed on the display device and determining the winner of the auction by combining the weighting factor for the one of the advertisers with the price the one of the advertisers is willing to pay for the advertisement.

26. The method of performing, with one or more processors, an auction of claim 25, including storing, in one or more databases on a non-transitory computer readable memory, as part of the information regarding an advertiser, one or more filtering criteria used in the auction, and wherein performing, with one or more processors, the auction includes filtering the advertisers who have geographical locations within the geographical boundary associated with the map displayed on the display device based on the one or more filtering criteria.

27. A computer system for performing an auction for the placement of an advertisement on a display device, comprising:
a data collection unit that includes one or more processors that collects advertising data from each of a multiplicity of advertisers willing to participate in an advertising auction, the data collection unit collecting, for each of the multiplicity of advertisers, an advertisement for display on the display device, a price the advertiser is willing to pay for the display of the advertisement on the display device and an indication of a geographical location of one or more physical sites associated with each of the multiplicity of advertisers;
a data storage unit that includes one or more databases on a non-transitory computer readable memory that stores the advertisement, the price the advertiser is willing to pay for the display of the advertisement on the display device and the indications of the geographical locations of the one or more physical sites associated with the advertiser for each of the multiplicity of advertisers; and
an auction unit that includes one or more processors that performs an advertisement auction between one or more of the advertisers having a physical site within a specified geographical region as determined from the indications of the geographical location of the one or more physical sites associated with the advertisers as stored in the data storage unit, using the price each of the advertisers is willing to pay for the display of the advertisement on the display device and the distance between the display device and the physical sites associated with the advertisers to determine a winner of the auction.

28. The system for performing an auction of claim 27, wherein the auction unit that includes one or more processors limits the auction to those advertisers that have an associated physical site within the specified geographical region as determined from the data storage unit that includes one or more databases on a non-transitory computer readable memory.

29. (canceled)
